(19) United States
(12) Patent Application Publication
(10) Pub. No.: US 2026/0110996 A1
(43) Pub. Date: Apr. 23, 2026

(54) PHYSICAL VAPOR DEPOSITION PROCESS MODELING

(71) Applicant: Applied Materials, Inc., Santa Clara, CA (US)

(72) Inventors: Piyush Navinchandra Bhatt, Mumbai (IN); Phillip Stout, Santa Clara, CA (US); Rajesh Sathiyanarayanan, Bangalore (IN); Karthik Ramanathan, Bangalore (IN); Jianxin Lei, Saratoga, CA (US); Wenting Hou, San Jose, CA (US)

(21) Appl. No.: 19/070,216

(22) Filed: Mar. 4, 2025

(30) Foreign Application Priority Data
Oct. 22, 2024 (IN) 202441080220

(51) Int. Cl. G05B 19/042

(52) U.S. Cl. CPC G05B 19/0426; G05B 19/0423

(57) ABSTRACT

A method includes obtaining, via a graphical user interface (GUI), simulation inputs including chamber configuration parameters, process recipe parameters, and substrate geometry parameters. The method further includes providing the simulation inputs to a physical vapor deposition (PVD) model. The method further includes obtaining output from the PVD model, including predicted properties of a substrate processed in accordance with the simulation inputs. The method further includes providing an alert to a user including the predicted properties, including a numerical or graphical representation of substrate properties, via one or more elements of the GUI.

### RELATED APPLICATIONS

This application claims the benefit of Indian Provisional Patent Application No. 202441080220, filed 22 Oct. 2024, the content of which is hereby incorporated by reference in its entirety.

### TECHNICAL FIELD

The present disclosure relates to methods associated with performing process modeling for substrate processing operations. Specifically, the present disclosure relates to methods associated with performing physical vapor deposition process modeling.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Product properties may include repeatability, e.g., freedom of products from defects. Machine learning models are used in various process control and predictive functions associated with manufacturing equipment. Machine learning models are trained using data associated with the manufacturing equipment. Output of machine learning models may be associated with predicted output of process operations.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes providing simulation inputs including chamber configuration parameters, process recipe parameters, and substrate geometry parameters to a physical vapor deposition (PVD) model. The method further includes obtaining output from the PVD model, including predicted properties of a substrate processed in accordance with the simulation inputs. The method further includes providing an alert to a user including the predicted properties.

In another aspect of the disclosure, a method includes obtaining training data. The training data includes simulation inputs. The simulation inputs include chamber configuration parameters, process recipe parameters, and substrate geometry parameters. The method further includes obtaining target output data including properties of a plurality of substrates processed in accordance with the training input data in a PVD process. The method further includes training a machine learning model to generate a trained machine learning model based on the training data and the target output data.

In another aspect of the present disclosure, a non-transitory machine-readable storage medium stores instructions which, when executed, cause a processing device to perform operations including providing simulation inputs to a PVD model. The simulation inputs include chamber configuration parameters, process recipe parameters, and substrate geometry parameters. The operations further include obtaining output from the PVD model including predicted properties of a substrate processed in accordance with the simulation inputs. The operations further include providing an alert to a user including the predicted properties.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2 depicts a block diagram of a system including an example data set generator for creating data sets for one or more supervised models, according to some embodiments.

FIG. 3 is a block diagram illustrating a system for generating output data, according to some embodiments.

FIG. 4A is a flow diagram of a method for generating a data set for a machine learning model, according to some embodiments.

FIG. 4B is a flow diagram of a method for utilizing a model for predicting and/or correcting a PVD process of a substrate processing system, according to some embodiments.

FIG. 4C is a flow diagram of a method for training a machine learning model to generate predictive PVD data, according to some embodiments.

FIG. 5A depicts an example input graphical user interface (GUI) for operation of a PVD model in association with substrate processing operations, according to some embodiments.

FIG. 5B depicts an example output GUI for displaying results associated with performing PVD modeling, according to some embodiments.

FIG. 6 is a block diagram illustrating a computer system, according to some embodiments.

### DETAILED DESCRIPTION

Described herein are technologies related to improving processes of substrate manufacturing, in particular physical vapor deposition (PVD) processes. Manufacturing equipment is used to produce products, such as substrates (e.g., wafers, semiconductors). Manufacturing equipment may include a manufacturing or processing chamber to separate the substrate from the environment. The properties of produced substrates are to meet target values to facilitate specific functionalities. Manufacturing parameters are selected to produce substrates that meet the target property values. Many manufacturing parameters (e.g., hardware parameters, process parameters, etc.) contribute to the properties of processed substrates. Manufacturing systems may control parameters by specifying a set point for a property value and receiving data from sensors disposed within the manufacturing chamber, and making adjustments to the manufacturing equipment until the sensor readings match the set point. Adjustments made to the manufacturing equipment may be made based on one or more metrics. For example, a change in gas flow or pressure may be performed by adjusting a valve, and a speed of adjustment of the valve may be controlled by one or more control parameters in association with the process recipe, the process chamber, or the like.

Various types of models may be applied in several ways associated with processing chambers and/or manufacturing equipment. Models applicable to a process chamber may include a physics-based model, a digital twin model, a statistical model, a machine learning model, or the like.

In some systems, there may be many input variables (e.g., process parameters, recipe set points, process chamber configurations, input substrate properties, etc.) defining a high-dimensional process space. Determining optimum conditions (e.g., processing conditions) for a target outcome may be an inconvenient, time-consuming, and/or expensive process.

In some systems, determining target processing conditions or process parameters may include performing experiments on a series of substrates. For example, many substrates may be subjected to PVD processes, and the resulting processed substrates measured, iteratively to design a target process meeting target criteria. This may be an expensive process, in terms of materials, process time, process design time, energy expenditure, subject matter expertise, environmental impact, cost associated with discarding test substrates, degradation of process equipment, opportunity cost of utilizing equipment for process design instead of substrate processing, etc.

Aspects of the present disclosure may address one or more shortcomings of conventional systems. In some embodiments, a model representing a PVD process may be utilized. The model may be a physics-based model. The model may be a statistical model. The model may be a trained machine learning model. The model may be a combination of multiple models, including one or more types of models. The model may predict outcomes of PVD processes performed on substrates, based on simulation inputs related to PVD process inputs.

The model may obtain multiple types of inputs to determine the predictive output (e.g., output indicative of properties of a substrate processed in accordance with process inputs consistent with the simulation inputs). Inputs to the model may include chamber configuration inputs (e.g., chamber configuration parameters). Inputs to the model may include process recipe inputs. Inputs to the model may include substrate geometry parameters (e.g., properties of substrates provided to the PVD process).

Chamber configuration inputs may include parameters related to process chamber set-up, hardware components, chamber selection, etc. Chamber configuration inputs may include selection of a model or design of a process chamber. For example, different modeling parameters (or a different trained machine-learning model) may be utilized for different types of process chambers, with different geometries or other properties that affect PVD and other processes. Chamber configuration inputs may include selection of a sputtering target material for PVD, e.g., a deposition material. Chamber configuration inputs may include selection of a sputter gas, e.g., argon, nitrogen, helium, krypton, etc. Chamber configuration inputs may include selection of a distance between a sputtering target and a deposition target, e.g., between a source of PVD material and a substrate.

Process recipe inputs may include any recipe inputs, recipe set points, or other conditions related to operations of a process chamber for performing a manufacturing process. Process recipe inputs may include process time, process temperature, process gas pressure, etc., Process recipe inputs may include plasma properties, including plasma energy, plasma ON time, etc. Process recipe inputs may include metal ion fraction, sputter gas ion fraction, etc. Process recipe inputs may include selection of a process type. For example, a process may include one or more deposition operations, deposition and etch operations, cyclic deposition operations, cyclic deposition and etch operations, etc. Process recipe inputs may include a selection of a number of cycles of cyclic processes, a selection of end conditions for cyclic processes, or the like.

Substrate geometry parameters may include properties of substrates provided to PVD operations. In some embodiments, feature properties (e.g., feature dimensions, feature geometry, etc.) may be provided. Common features may be collected for convenient entry of properties, e.g., trenches or vias. A user may instead or additionally have an option of inputting an arbitrary geometry, e.g., from a file describing properties at various coordinates of the substrate, directly from a metrology device, or the like.

In some embodiments, a graphical user interface (GUI) may be provided for collection of simulation inputs and display of results. The graphical user interface may include fillable fields for determining process parameters, such as those discussed above. The graphical user interface may provide various layouts, e.g., based on user selections. For example, a selection of a common feature type may determine which feature properties are provided, etc. The GUI may be used to indicate a type of process, a number of cycles of the process, etc. In some embodiments, a user may cause a number of different scenarios to be investigated, e.g., cause a range of one or more parameters to be explored to determine how the process inputs affect process outputs. In some embodiments, the GUI may be used to indicate a target process output, e.g., a type of deposition operation, such as a liner application for coating features of a substrate or gapfill applications to fill a feature with deposited material.

In some embodiments, the model that predicts process outputs may be or include or more physics-based models. In some embodiments, the PVD model may include a plasma model and an interaction model (plasma-surface interaction model), such as a kinetic Monte Carlo model or a level set model. In some embodiments, the model may be a trained machine learning model. In some embodiments, the model may be a data-based model that is trained based on output of a physics-based model.

In some embodiments, a system for performing inference operations of the PVD model may further perform a corrective action. The corrective action may include updating a process recipe. The corrective action may include scheduling reconfiguration of a process chamber. The corrective action may include scheduling maintenance of the process chamber.

In some embodiments, the GUI may be utilized to provide output data of the PVD model. The GUI may provide numerical, tabulated, graphical, or the like data for review by a user, for use in process design, for use in process verification, for use in chamber validation or maintenance, or the like.

Aspects of the present disclosure provide technical advantages over conventional methods. Costs associated with recipe development, recipe updates, predictions of process recipe adjustments, and the like may be significantly reduced by utilizing a system such as that described herein. Development of a new product, new recipe, incorporation of a new type of process chamber into an existing workflow, adjustment to improve one or more performance metrics of the process, or the like may be performed without incurring costs associated with performing a large number of physical experiments.

In one aspect of the present disclosure, a method includes providing simulation inputs including chamber configuration parameters, process recipe parameters, and substrate geometry parameters to a PVD model. The method further includes obtaining output from the PVD model including predicted properties of a substrate processed in accordance with the simulation inputs. The method further includes providing an alert to a user, including the predicted properties.

In another aspect of the present disclosure, a method includes obtaining training input data including first simulation inputs. The first simulation inputs include chamber configuration parameters, process recipe parameters, and substrate geometry parameters. The method further includes obtaining target output data including properties of a plurality of substrates processed in accordance with the training input data in a PVD process. The method further includes training a machine learning model to generate a trained machine learning model based on the training input data and the target output data.

In another aspect of the present disclosure, a non-transitory machine-readable storage medium stores instructions which, when executed, cause a processing device to perform operations. The operations include providing simulation inputs including chamber configuration parameters, process recipe parameters, and substrate geometry parameters to a PVD model. The operations further include obtaining output from the PVD model including predicted properties of a substrate processed in accordance with the simulation inputs. The operations further include providing an alert to a user, including the predicted properties.

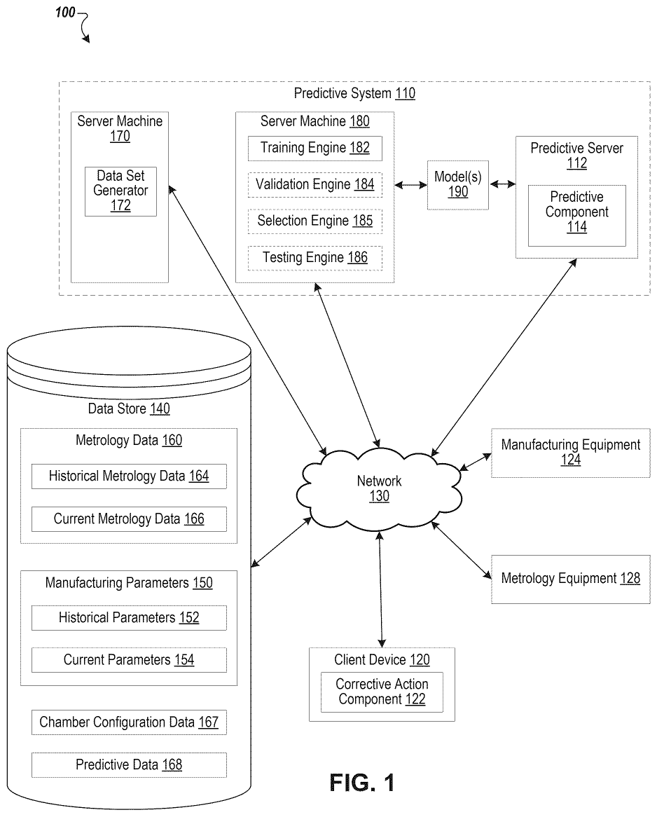

FIG. 1 is a block diagram illustrating an exemplary system 100 (exemplary system architecture), according to some embodiments. The system 100 includes a client device 120, manufacturing equipment 124, metrology equipment 128, predictive server 112, and data store 140. The predictive server 112 may be part of predictive system 110. Predictive system 110 may further include server machines 170 and 180.

Manufacturing equipment 124 may include one or more process tools, process chambers, or the like for performing processing operations to manufacture substrates. Substrates may have property values (film thickness, film strain, etc.) measured by metrology equipment 128. Metrology data 160 may be a component of data store 140. Metrology data 160 may include historical metrology data 164 (e.g., metrology data associated with previously processed products). In some embodiments, historical metrology data 164 may be used in training a machine leaning model, in calibrating a physics-based model, in generating a reduced-order model, or the like. Historical metrology data 164 may be utilized in determining a historical likelihood of developing substrate defects, and the historical likelihood may be utilized in generating a machine learning model, in calibrating a physics-based model, in determining whether to use a model in association with a process of interest, or the like.

Metrology data 160 may be provided by instruments separate from a manufacturing mainframe, e.g., substrates may be measured at a standalone metrology facility. In some embodiments, metrology data 160 may be provided without use of a standalone metrology facility, e.g., in-situ metrology data (e.g., metrology or a proxy for metrology collected during processing), integrated metrology data (e.g., metrology or a proxy for metrology collected while a product is within a chamber or under vacuum, but not during processing operations), inline metrology data (e.g., data collected after a substrate is removed from vacuum), etc. Metrology data 160 may include current metrology data 166 (e.g., metrology data associated with a product currently or recently processed, e.g., for updating one or more models responsive to drifting or aging chamber components or conditions). Current metrology data may be provided to update one or more models in association with defect root cause correction, e.g., by updating weights or biases of a machine learning model, updating parameters of a physics-based model, updating coefficients of a reduced order model, or the like

Data store 140 may further include manufacturing parameters 150. Manufacturing parameters 150 may include parameters associated with performing substrate processing procedures, such as recipe data (e.g., process parameters), equipment constants (e.g., hardware parameters, parameters determining how operations of manufacturing equipment 124 are performed), indications of installed hardware components, or the like. Manufacturing parameter data, similar to metrology data 160, may include historical parameters 152 and current parameters 154. Historical parameters 152 may be utilized in generating a model (e.g., one or more models 190) for defect correction, e.g., to be used to reduce a likelihood of developing a defect during substrate processing. Defects that may be reduced based on techniques and systems of the current disclosure include particle defects, voids (e.g., in gapfill applications), seams (e.g., non-ideal boundaries between layers), non-conformality across the substrate, or the like. Current parameters 154 may be utilized in determining whether a process of interest is likely to generate substrate defects, e.g., by providing the current parameters 154 (e.g., parameters of interest) to model 190. Current parameters 154 (e.g., associated with recently processed products) may be used for adjusting, retraining, or recalibrating one or more models associated with manufacturing equipment 124, e.g., PVD models associated with manufacturing equipment 124.

Data store 140 further includes chamber configuration data 167. Chamber configuration data may include descriptions or data associated with adjustable metrics of a process chamber, e.g., distances between various components, materials used for one or more processes, or the like. Chamber configuration data may be used, in a similar manner to metrology data 160 and/or manufacturing parameters 150, for generating a trained machine learning model, for calibrating a physics-based or other model, for providing as input to a model, for verifying or updating one or more models (e.g., PVD models), etc.

In some embodiments metrology data 160 and/or manufacturing parameters 150 may be processed (e.g., by the client device 120 and/or by the predictive server 112).

Processing of the data may include generating features. In some embodiments, the features are a pattern in the metrology data 160 and/or manufacturing parameters 150 (e.g., slope, width, height, peak, etc.) or a combination of values from the metrology data and/or manufacturing parameters (e.g., power derived from voltage and current, etc.). Manufacturing parameters 150 may include features and the features may be used by predictive component 114 for performing signal processing and/or for obtaining predictive data 168 for performance of a corrective action.

Each instance of metrology data 160 and/or manufacturing parameters 150 may correspond to a product, a set of manufacturing equipment, a type of substrate produced by manufacturing equipment, or the like. A model 190 may also be associated with a particular product, substrate design, set of manufacturing equipment, design of manufacturing chamber, or the like. For example, a PVD model, which may include models describing high-energy particles, models describing deposition particle interaction with a substrate, or other models, may be generated based on geometry of a type or design of process tool. A reduced order or machine learning model may be generated based on data from a particular design of chamber or a specific specimen of process chamber (e.g., to account for differences between nominally identical chambers), or the like. The data store may further store information associating sets of different data types, e.g. information indicative that a set of sensor data, a set of metrology data, and a set of manufacturing parameters are all associated with the same product, manufacturing equipment, type of substrate, etc.

In some embodiments, a processing device (e.g., via a model) may be used to generate predictive data 168. Predictive data 168 may include one or more indications of predicted improvements to a processing operation (e.g., to improve efficiency, to improve reliability, to improve output substrate properties, to improve environmental impact, or the like). Predictive data 168 may be utilized by system 100 for performance of a corrective action (e.g., providing alerts to a user, updating or developing process recipes, updating manufacturing parameters, scheduling maintenance, or the like).

In some embodiments, predictive system 110 may generate predictive data 168 utilizing a physics-based model. A physics-based model may include a mathematical representation of the laws of nature at play in the process chamber. The physics-based model may be a first principles model, an approximate model, or the like. The physics-based model may include a representation or parameterization of chamber geometry, pumping parameters, gas flow parameters, plasma generation parameters, or the like. The physics-based model may be or include a plasma model, a level set model, a kinetic Monte Carlo model, or the like. A physics-based model may include one or more parameters that are allowed to be adjusted to fit the physics-based model to data, e.g., historical metrology data 164, e.g., to account for details of physics of the process chamber not captured by the original model parameters.

In some embodiments, predictive system 110 may generate predictive data 168 utilizing a reduced order model. A reduced order model may include a simplified version of a complex model (e.g., a simplified version of a physics-based model). The reduced order model may mimic the performance of the full model under a target range of conditions (e.g., relevant to substrate processing conditions), while being more computationally efficient. Training data (e.g., historical metrology data 164, historical parameters 152, etc.) may be utilizing in determining which simplifications from a more complete model to make, in determining coefficients of a reduced order model, or the like.

In some embodiments, predictive system 110 may generate predictive data 168 using supervised machine learning (e.g., predictive data 168 includes output from a machine learning model that was trained using labeled data, such as manufacturing parameter data labelled with metrology data). Metrology data may for example include deposition profiles, etch profiles, or other metrology of interest. In some embodiments, predictive system 110 may generate predictive data 168 using unsupervised machine learning (e.g., predictive data 168 includes output from a machine learning model that was trained using unlabeled data, output may include clustering results, principle component analysis, anomaly detection, etc.). In some embodiments, predictive system 110 may generate predictive data 168 using semi-supervised learning (e.g., training data may include a mix of labeled and unlabeled data, etc.).

Client device 120, manufacturing equipment 124, metrology equipment 128, predictive server 112, data store 140, server machine 170, and server machine 180 may be coupled to each other via network 130 for generating predictive data 168, e.g., to perform corrective actions. In some embodiments, network 130 may provide access to cloud-based services. Operations performed by client device 120, predictive system 110, data store 140, etc., may be performed by virtual cloud-based devices.

In some embodiments, network 130 is a public network that provides client device 120 with access to the predictive server 112, data store 140, and other publicly available computing devices. In some embodiments, network 130 is a private network that provides client device 120 access to manufacturing equipment 124, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to the predictive system 110, receives output (e.g., predictive data 168) from the predictive system 110, determines a corrective action based on the output, and causes the corrective action to be implemented. In some embodiments, corrective action component 122 obtains model input data associated with manufacturing equipment 124 (e.g., from data store 140, etc.) and provides the model input data (e.g., current parameters 154) associated with the manufacturing equipment 124 to predictive system 110.

In some embodiments, corrective action component 122 receives an indication of a corrective action from the predictive system 110 and causes the corrective action to be implemented. Each client device 120 may include an operating system that allows users to one or more of generate, view, or edit data (e.g., indication associated with manufacturing equipment 124, corrective actions associated with manufacturing equipment 124, etc.).

In some embodiments, metrology data 160 (e.g., historical metrology data 164) corresponds to historical property data of products (e.g., products processed using manufacturing parameters associated with historical manufacturing parameters 152) and predictive data 168 is associated with predicted property data (e.g., of products to be produced or that have been produced in conditions recorded by current manufacturing parameters 154). In some embodiments, predictive data 168 is or includes predicted metrology data (e.g., virtual metrology data, particle defect generation likelihood) of the products to be produced or that have been produced according to conditions recorded as current measurement data and/or current manufacturing parameters. In some embodiments, predictive data 168 is or includes an indication of any abnormalities (e.g., abnormal products, abnormal components, abnormal manufacturing equipment 124, abnormal energy usage, etc.) and optionally one or more causes of the abnormalities. In some embodiments, predictive data 168 is an indication of change over time or drift in some component of manufacturing equipment 124, metrology equipment 128, and the like. In some embodiments, predictive data 168 is an indication of an end of life of a component of manufacturing equipment 124, metrology equipment 128, or the like.

Developing manufacturing processes that provide target on-substrate results can be an expensive process, in terms of time of recipe development, time of experts to determine recipe parameters and define experimental parameters, time of technicians to perform testing, cost of materials to test, cost of disposing of test materials, energy costs and environmental costs associated with performing experiments, chamber process time devoted to experiments, etc. By providing data indicative of manufacturing parameters to a model (e.g., model 190) and receiving predictive data 168 indicative of predicted metrology of a substrate processed in accordance with the input data, system 100 can include the technical advantage of avoiding costs associated with performing physical experiments for design of PVD process recipes.

Performing manufacturing processes that result in defective products can be costly in time, energy, products, components, manufacturing equipment 124, the cost of identifying the defects and discarding the defective product, etc. By inputting manufacturing parameters that are being used or are to be used to manufacture a product into predictive system 110, receiving output of predictive data 168, and performing a corrective action based on the predictive data 168, system 100 can have the technical advantage of avoiding the cost of producing, identifying, and discarding defective products.

Performing manufacturing processes that result in failure of the components of the manufacturing equipment 124 can be costly in downtime, damage to products, damage to equipment, express ordering replacement components, etc. By inputting manufacturing parameters that are being used or are to be used to manufacture a product, metrology data, measurement data, etc., receiving output of predictive data 168, and performing corrective action (e.g., predicted operational maintenance, such as replacement, processing, cleaning, etc. of components causing particles to be deposited on substrates during processing) based on the predictive data 168, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, metrology equipment 128, and the like, may provide indications of degrading components.

Manufacturing parameters may be suboptimal for producing product which may have costly results of increased resource (e.g., energy, coolant, gases, etc.) consumption, increased amount of time to produce the products, increased component failure, increased amounts of defective products, etc. By inputting indications of manufacturing parameters 150 into a model 190, receiving an output of predictive data 168, and performing a corrective action of updating manufacturing parameters (e.g., setting optimal manufacturing parameters, updating a process recipe, or the like), system 100 can have the technical advantage of using optimal manufacturing parameters (e.g., hardware parameters, process parameters, optimal design) to avoid costly results of suboptimal manufacturing parameters, including reducing a likelihood of developing particle defects on substrates, maintaining high product throughput while managing a likelihood of developing defects, or the like.

In some embodiments, the corrective action includes providing an alert (e.g., an alarm to stop or not perform the manufacturing process if the predictive data 168 indicates a predicted abnormality, such as an abnormality of the product, a component, or manufacturing equipment 124). In some embodiments, performance of the corrective action includes causing updates to one or more manufacturing parameters. In some embodiments, performance of a corrective action may include recalibration or adjustment of parameters of a physics-based model or reduced order model. In some embodiments performance of a corrective action may include retraining a machine learning model associated with manufacturing equipment 124. In some embodiments, performance of a corrective action may include training a new machine learning model associated with manufacturing equipment 124. In some embodiments, performance of a corrective action may include updating target substrate properties to be provided to a process operation associated with the PVD modeling, e.g., updating properties of an input substrate.

Manufacturing parameters 150 may include hardware parameters (e.g., information indicative of which components are installed in manufacturing equipment 124, indicative of component replacements, indicative of component age, indicative of software version or updates, etc.) and/or process parameters (e.g., temperature, pressure, flow, rate, electrical current, voltage, gas flow, lift speed, etc.). In some embodiments, the corrective action includes causing preventative operative maintenance (e.g., replace, process, clean, etc. components of the manufacturing equipment 124). In some embodiments, the corrective action includes causing design optimization (e.g., updating manufacturing parameters, manufacturing processes, manufacturing equipment 124, etc. for an optimized product). In some embodiments, the corrective action includes a updating a recipe (e.g., altering the timing of manufacturing subsystems entering an idle or active mode, altering set points of various property values, etc.). In some embodiments, a corrective action includes updating a duration of one or more processing actions, such as opening or closing a valve, adjusting a flow meter, or the like. In some embodiments, a corrective action includes updating chamber configuration, such as adjusting a distance between a sputtering target and substrate in a PVD process chamber.

Predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of predictive server 112, server machine 170, server machine 180, data store 140, etc., may be performed by a cloud computing service, cloud data storage service, etc.

Predictive server 112 may include a predictive component 114. In some embodiments, the predictive component 114 may receive current manufacturing parameters (e.g., receive from the client device 120, retrieve from the data store 140) and generate output (e.g., predictive data 168) for performing corrective action associated with the manufacturing equipment 124 based on the current data. In some embodiments, predictive data 168 may include one or more predicted defects of a processed product. In some embodiments, predictive data 168 may include a prediction of conditions in-chamber that may result in defect formation, such as gas backflow. In some embodiments, predictive component 114 may use one or more trained machine learning models 190 to determine the output for performing the corrective action based on current data.

Manufacturing equipment 124 may be associated with one or more models, e.g., model 190. In some embodiments, model(s) 190 may be or include physics-based models, reduced order models, machine learning models, etc. Models associated with manufacturing equipment 124 may perform many tasks, including process control, classification, performance predictions, etc. Model 190 may be trained using data associated with manufacturing equipment 124 or products processed by manufacturing equipment 124, e.g., sensor data, manufacturing parameters 150 (e.g., associated with process control of manufacturing equipment 124), metrology data 160 (e.g., generated by metrology equipment 128), etc.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, predictive component 114 current metrology data 166 and/or current manufacturing parameters 154, performs signal processing to break down the current data into sets of current data, provides the sets of current data as input to a trained model 190, and obtains outputs indicative of predictive data 168 from the trained model 190. In some embodiments, predictive component 114 receives metrology data (e.g., predicted defect formation likelihood) of a substrate and provides the metrology data to trained model 190. Model 190 may be configured to accept data indicative of manufacturing parameters and generate as output defect formation data. In some embodiments, predictive data is indicative of metrology data (e.g., prediction of substrate quality, substate defect likelihood, or the like). In some embodiments, predictive data is indicative of manufacturing equipment health (e.g., an indication of a component or components likely to be contributing to substrate defects).

In some embodiments, the various models discussed in connection with model 190 (e.g., supervised machine learning model, unsupervised machine learning model, etc.) may be combined in one model (e.g., an ensemble model), or may be separate models.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store manufacturing parameters 150, metrology data 160, chamber configuration data 167, and predictive data 168.

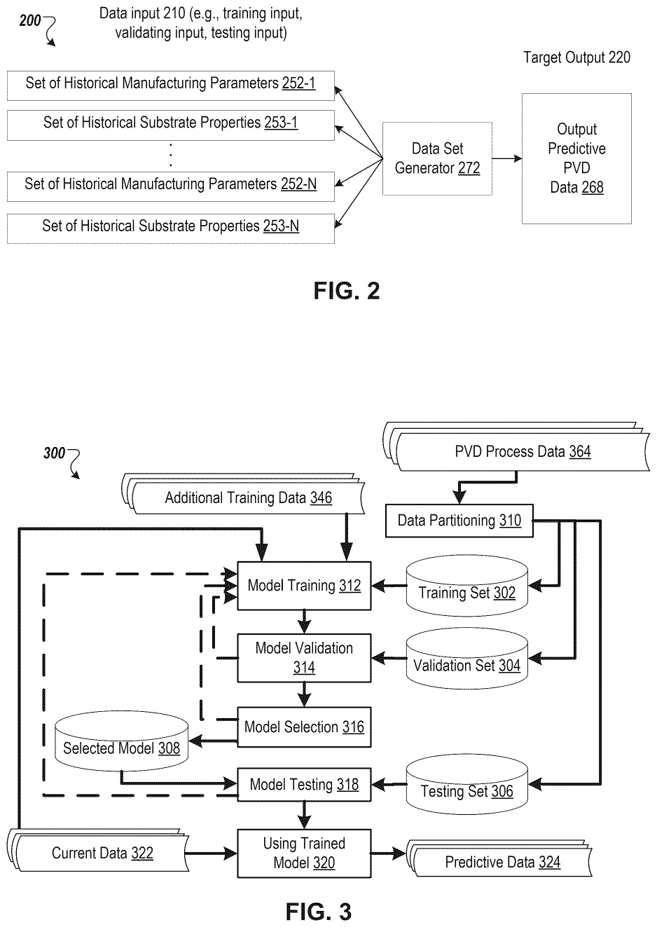

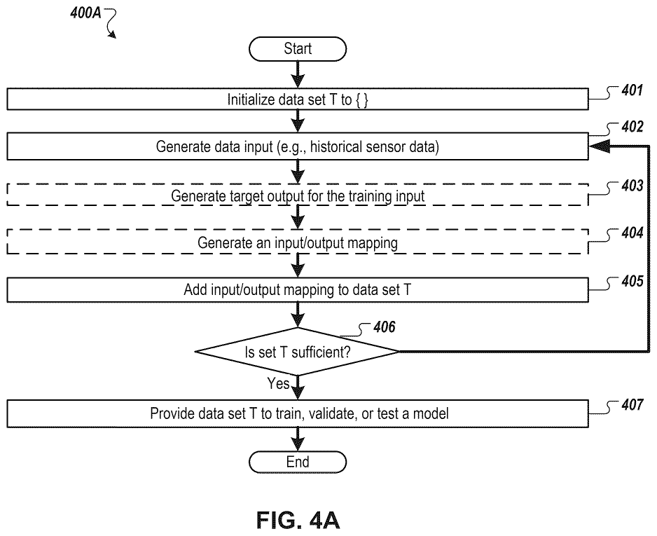

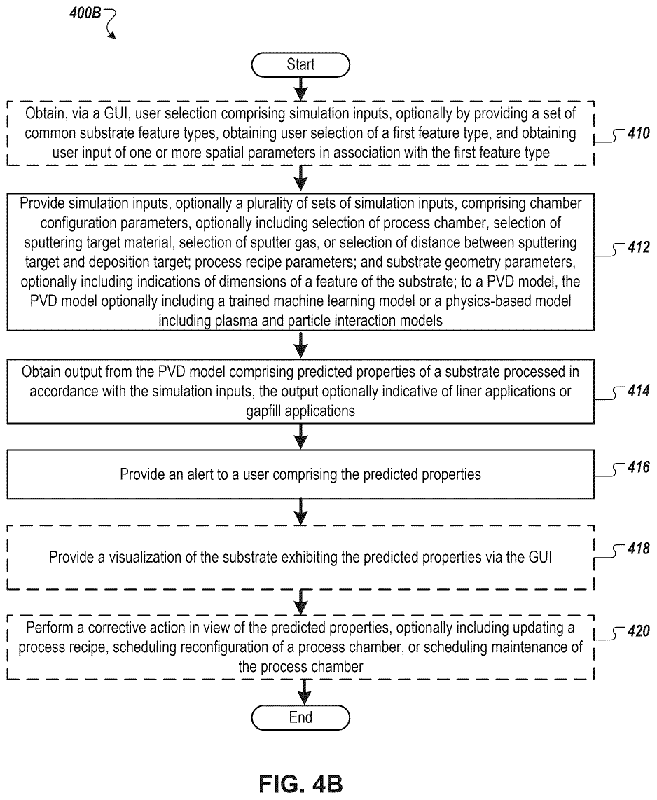

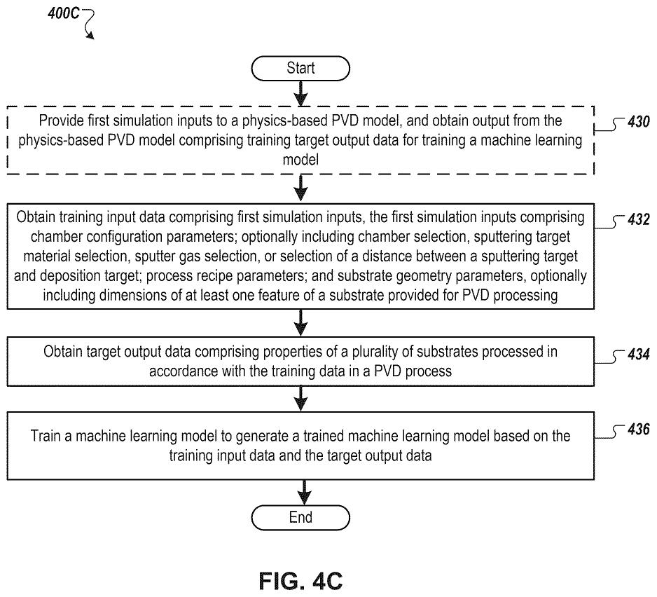

In some embodiments, predictive system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIGS. 2 and 4A. In some embodiments, data set generator 172 may partition the historical data (e.g., historical manufacturing parameters 152, historical metrology data 164) into a training set (e.g., sixty percent of the historical data), a validating set (e.g., twenty percent of the historical data), and a testing set (e.g., twenty percent of the historical data).

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model 190 using one or more sets of features associated with the training set from data set generator 172. The training engine 182 may generate multiple trained models 190, where each trained model 190 corresponds to a distinct set of features of the training set. For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features. Data set generator 172 may receive the output of a trained, collect that data into training, validation, and testing data sets, and use the data sets to train a second model (e.g., a machine learning model configured to output predictive data, corrective actions, etc.).

Validation engine 184 may be capable of validating a trained model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model 190 that has the highest accuracy of the trained models 190.

Testing engine 186 may be capable of testing a trained model 190 using a corresponding set of features of a testing set from data set generator 172. For example, a first trained machine learning model 190 that was trained using a first set of features of the training set may be tested using the first set of features of the testing set. Testing engine 186 may determine a trained model 190 that has the highest accuracy of all of the trained models based on the testing sets.

In the case of a machine learning model, model 190 may refer to the model artifact that is created by training engine 182 using a training set that includes data inputs and corresponding target outputs (correct answers for respective training inputs. Patterns in the data sets can be found that map the data input to the target output (the correct answer), and machine learning model 190 is provided mappings that capture these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc. In some embodiments, one or more machine learning models 190 may be trained using historical data (e.g., historical parameters 152).

Predictive component 114 may provide current data to model 190 and may run model 190 on the input to obtain one or more outputs. For example, predictive component 114 may provide current parameters 154 to model 190 and may run model 190 on the input to obtain one or more outputs indicative of product properties processed in accordance with the input. Predictive component 114 may be capable of determining (e.g., extracting) predictive data 168 from the output of model 190. Predictive component 114 may determine (e.g., extract) confidence data from the output that indicates a level of confidence that predictive data 168 is an accurate predictor of a process associated with the input data for products produced or to be produced using the manufacturing equipment 124 at the current manufacturing parameters. Predictive component 114 or corrective action component 122 may use the confidence data to decide whether to cause a corrective action associated with the manufacturing equipment 124 based on predictive data 168.

The confidence data may include or indicate a level of confidence that the predictive data 168 is an accurate prediction for products or components associated with at least a portion of the input data. In one example, the level of confidence is a real number between 0 and 1 inclusive, where 0 indicates no confidence that the predictive data 168 is an accurate prediction for products processed according to input data or component health of components of manufacturing equipment 124 and 1 indicates absolute confidence that the predictive data 168 accurately predicts properties of products processed according to input data or component health of components of manufacturing equipment 124. Responsive to the confidence data indicating a level of confidence below a threshold level for a predetermined number of instances (e.g., percentage of instances, frequency of instances, total number of instances, etc.) predictive component 114 may cause trained model 190 to be re-trained (e.g., based on current manufacturing parameters, current metrology, measurements of conditions in the chamber, etc.). In some embodiments, retraining may include generating one or more data sets (e.g., via data set generator 172) utilizing historical data.

For purpose of illustration, rather than limitation, aspects of the disclosure describe the training of one or more machine learning models 190 using historical data (e.g., historical metrology data 164, historical manufacturing parameters 152) and inputting current data (e.g., current manufacturing parameters, and current metrology data) into the one or more trained machine learning models to determine predictive data 168. In other embodiments, a heuristic model, physics-based model, or rule-based model is used to determine predictive data 168 (e.g., without using a trained machine learning model). In some embodiments, such models may be trained using historical data. In some embodiments, these models may be retrained utilizing a historical data and/or current data. Predictive component 114 may monitor historical manufacturing parameters, and metrology data 160. Any of the information described with respect to data inputs 210 of FIG. 2 may be monitored or otherwise used in the heuristic, physics-based, or rule-based model. For example, data collected in association with manufacturing equipment 124 may be used for calibrating a physics-based model, e.g., by adjusting one or more floating parameters of the model.

In some embodiments, the functions of client device 120, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, client device 120 and predictive server 112 may be integrated into a single machine. In some embodiments, functions of client device 120, predictive server 112, server machine 170, server machine 180, and data store 140 may be performed by a cloud-based service.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine the corrective action based on the predictive data 168. In another example, client device 120 may determine the predictive data 168 based on output from the trained machine learning model.

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

FIG. 2 depicts a block diagram of example data set generator 272 (e.g., data set generator 172 of FIG. 1) to create data sets for training, testing, validating, calibrating, etc. a model (e.g., model 190 of FIG. 1), according to some embodiments. Each data set generator 272 may be part of server machine 170 of FIG. 1. In some embodiments, data set generator 272 may generate data sets to be utilized to adjust, validate, test, or the like a physics-based model or reduced order model. In some embodiments, data set generator 272 may generate data sets to be utilized in generating, validating, etc., machine learning models in association with the manufacturing equipment. In some embodiments, several models associated with manufacturing equipment 124 may be trained, used, and maintained (e.g., within a manufacturing facility). One or more physics-based models, one or more reduced order models, and/or one or more trained machine learning models may be generated and maintained in association with the manufacturing equipment. Each model may be associated with one data set generators 272, multiple models may share a data set generator 272, etc.

FIG. 2 depicts a system 200 including data set generator 272 for creating data sets for one or more supervised models (e.g., including data associated with input to a model and output from the model). Data set generator 272 may create data sets (e.g., data input 210, target output 220) using historical data, which may include manufacturing parameters, chamber configuration, incoming substrate properties, and/or the like. In some embodiments, a data set generator similar to data set generator 272 may be utilized to train an unsupervised model, e.g., target output 220 may not be generated by data set generator 272.

Data set generator 272 may generate data sets to train, test, and validate a model, e.g., a machine learning model. Data set generator 272 may generate data sets to calibrate a model, e.g., a physics-based model (including reduced order models). In some embodiments, data set generator 272 may generate data sets for a machine learning model. In some embodiments, data set generator 272 may generate data sets for training, testing, and/or validating a model configured to predict output of a PVD process in a substrate processing system, such as generating data indicating a likelihood of defect formation, a predicted substrate geometry, predicted substrate properties, or the like.

A model to be generated (e.g., trained, calibrated, or the like) may be provided with a set of historical manufacturing parameters 252-1 as data input 210. The set of historical manufacturing parameters 252-1 may include process control set points. The set of historical manufacturing parameters 252-1 may include parameters determining actions of manufacturing equipment, such as ramp times for valve actuation. The set of historical manufacturing parameters 252-1 may include chamber configuration. The model may further be provided with set of historical substrate properties 253-1, including substrate properties corresponding to substrates provided to PVD processes corresponding to the processes described in set of historical manufacturing parameters 252-1. The model may be configured to accept indications of manufacturing parameters (e.g., current manufacturing parameters) as input and generate predictions related to particle defect generation as output.

Data set generator 272 may be used to generate data sets for any type of model used in association with predicting or correcting substrate properties of substrates undergoing PVD processes, including cyclic PVD processes and PVD/etch processes. Data set generator 272 may be used to generate data for any type of machine learning model that takes as input historical manufacturing parameter data, and/or input substrate property data (e.g., geometries of features of substrates provided to the PVD process). Data set generator 272 may be used to generate data for a machine learning model that generates predicted defect generation data. Data set generator 272 may be used to generate data for a machine learning model configured to provide process update instructions, e.g., configured to update manufacturing parameters, manufacturing recipes, equipment constants, or the like. Data set generator 272 may be used to generate data for a machine learning model configured to identify a product anomaly and/or processing equipment fault.

In some embodiments, data set generator 272 generates a data set (e.g., training set, validating set, testing set) that includes one or more data inputs 210 (e.g., training input, validating input, testing input). Data inputs 210 may be provided to training engine 182, validating engine 184, or testing engine 186. The data set may be used to train, validate, or test the model (e.g., model 190 of FIG. 1).

In some embodiments, data input 210 may include one or more sets of data. As an example, system 200 may produce sets of manufacturing parameter data that may include one or more of parameter data from one or more types of components, combinations of parameter data from one or more types of components, patterns from parameter data from one or more types of components, or the like. In some embodiments, target output 220 may include sets of output related to the various sets of data input 210.

In some embodiments, data set generator 272 may generate a first data input corresponding to a first set of manufacturing parameters 252-1 to train, validate, or test a first machine learning model. Data set generator 272 may generate a second data input corresponding to a second set of historical manufacturing parameter data (e.g., a set of historical metrology data 252-2, not shown) to train, validate, or test a second machine learning model. Further sets of historical data may further be utilized in generating further machine learning models. Any number of sets of historical data may be utilized in generating any number of machine learning models, up to a final set, set of historical manufacturing parameters 252-N (N representing any target quantity of data sets, models, etc.). Further, a second set of historical substrate properties 253-2 (not shown), and further sets of historical substrate properties, up to set of historical substrate properties 253-N, may be generated to train, test, validate, calibrate, or the like a PVD model.

In some embodiments, data set generator 272 may generate a first data input corresponding to a first set of historical manufacturing parameters 252-1 and first set of historical substrate properties 253-1 to train, validate, or test a first machine learning model. Data set generator 272 may generate a second data input corresponding to a second set of historical manufacturing parameters 252-2 and second set of historical substrate properties 253-2 (not shown) to train, validate, or test a second machine learning model.

In some embodiments, data set generator 272 generates a data set (e.g., training set, validating set, testing set) that includes one or more data inputs 210 (e.g., training input, validating input, testing input) and may include one or more target outputs 220 that correspond to the data inputs 210. The data set may also include mapping data that maps the data inputs 210 to the target outputs 220. In some embodiments, data set generator 272 may generate data for training a model configured to output relevant to preventing particle defect formation, by generating data sets including output predictive PVD data 268. Data inputs 210 may also be referred to as “features,” “attributes,” or “information.” In some embodiments, data set generator 272 may provide the data set to training engine 182, validating engine 184, or testing engine 186, where the data set is used to train, validate, or test the model (e.g., one of the machine learning models that are included in model 190, ensemble model 190, etc.).

In some embodiments, subsequent to generating a data set and training, validating, or testing a machine learning model using the data set, the model may be further trained, validated, or tested, or adjusted (e.g., adjusting weights or parameters associated with input data of the model, such as connection weights in a neural network).

FIG. 3 is a block diagram illustrating system 300 for generating output data (e.g., predictive data 168 of FIG. 1), according to some embodiments. In some embodiments, system 300 may be used in conjunction with a model (e.g., physics-based, reduced order, data-based, machine learning, or the like) configured to generate predictive data related to particle defect generation. In some embodiments, system 300 is utilized for generating output data by a model such as model 190 of FIG. 1. In some embodiments, system 300 may be used in conjunction with a model to predict output of a PVD process. In some embodiments, system 300 may be used in conjunction with a model to determine a corrective action associated with manufacturing equipment. In some embodiments, system 300 may be used in conjunction with a model to determine a fault of manufacturing equipment, e.g., a component resulting in a PVD process generating unexpected results. In some embodiments, system 300 may be used in conjunction with a machine learning model to cluster or classify substrates or substrate defects. System 300 may be used in conjunction with a machine learning model with a different function than those listed, associated with a manufacturing system.

At block 310, system 300 (e.g., components of predictive system 110 of FIG. 1) performs data partitioning (e.g., via data set generator 172 of server machine 170 of FIG. 1) of data to be used in training, validating, and/or testing a model, such as a machine learning model. In some embodiments, PVD process data 364 includes historical data, such as historical metrology data (e.g., substrate properties before and/or after a PVD process), historical manufacturing parameter data, measured chamber condition data, etc. In some embodiments, e.g., when utilizing physics-based model data to train a machine learning model, PVD process data 364 may include data output by a physics-based model (e.g., a computationally expensive model). PVD process data 364 may undergo data partitioning at block 310 to generate training set 302, validation set 304, and testing set 306. For example, the training set may be 60% of the training data, the validation set may be 20% of the training data, and the testing set may be 20% of the training data.

The generation of training set 302, validation set 304, and testing set 306 may be tailored for a particular application. For example, the training set may be 60% of the training data, the validation set may be 20% of the training data, and the testing set may be 20% of the training data. System 300 may generate a plurality of sets of features for each of the training set, the validation set, and the testing set. For example, if PVD process data 364 includes manufacturing parameters, including features derived from 20 recipe parameters and 10 hardware parameters, the data may be divided into a first set of features including recipe parameters 1-10 and a second set of features including recipe parameters 11-20. The hardware parameters may also be divided into sets, for instance a first set of hardware parameters including parameters 1-5, and a second set of hardware parameters including parameters 6-10. Either target input, target output, both, or neither may be divided into sets. Multiple models may be trained on different sets of data.

At block 312, system 300 performs model training (e.g., via training engine 182 of FIG. 1) using training set 302. Training of a machine learning model and/or of a physics-based model (e.g., a digital twin) may be achieved in a supervised learning manner, which involves providing a training dataset including labeled inputs through the model, observing its outputs, defining an error (by measuring the difference between the outputs and the label values), and using techniques such as deep gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to perform anomaly detection, result clustering, etc.

For each training data item in the training dataset, the training data item may be input into the model (e.g., into the machine learning model). The model may then process the input training data item (e.g., one or more manufacturing parameter values, etc.) to generate an output. The output may include, for example, predicted substrate properties. The output may be compared to a label of the training data item (e.g., a measured substrate property).

Processing logic may then compare the generated output (e.g., predicted substrate properties) to the label (e.g., measured substrate properties) that was included in the training data item. Processing logic determines an error (i.e., a classification error) based on the differences between the output and the label(s). Processing logic adjusts one or more weights and/or values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

System 300 may train multiple models using multiple sets of features of the training set 302 (e.g., a first set of features of the training set 302, a second set of features of the training set 302, etc.). For example, system 300 may train a model to generate a first trained model using the first set of features in the training set (e.g., manufacturing parameter data from components 1-10, condition predictions 1-10, etc.) and to generate a second trained model using the second set of features in the training set (e.g., manufacturing parameter data from components 11-20, modeling process chamber conditions 11-20, etc.). In some embodiments, the first trained model and the second trained model may be combined to generate a third trained model (e.g., which may be a better predictor than the first or the second trained model on its own). In some embodiments, sets of features used in comparing models may overlap (e.g., first set of features being parameters 1-15 and second set of features being parameters 5-20). In some embodiments, hundreds of models may be generated including models with various permutations of features and combinations of models.

At block 314, system 300 performs model validation (e.g., via validation engine 184 of FIG. 1) using the validation set 304. The system 300 may validate each of the trained models using a corresponding set of features of the validation set 304. For example, system 300 may validate the first trained model using the first set of features in the validation set (e.g., parameters 1-10 or conditions 1-10) and the second trained model using the second set of features in the validation set (e.g., parameters 11-20 or conditions 11-20). In some embodiments, system 300 may validate hundreds of models (e.g., models with various permutations of features, combinations of models, etc.) generated at block 312. At block 314, system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. System 300 may discard the trained models that have an accuracy that is below the threshold accuracy (e.g., based on the validation set).

At block 316, system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via testing engine 186 of FIG. 1) using testing set 306 to test selected model 308. System 300 may test, using the first set of features in the testing set (e.g., parameters 1-10), the first trained model to determine the first trained model meets a threshold accuracy. Determining whether the first trained model meets a threshold accuracy may be based on the first set of features of testing set 306. Responsive to accuracy of the selected model 308 not meeting the threshold accuracy, flow continues to block 312 where system 300 performs model training (e.g., retraining) using different training sets corresponding to different sets of features. Accuracy of selected model 308 may not meet threshold accuracy if selected model 308 is overly fit to the training set 302 and/or validation set 304. Accuracy of selected model 308 may not meet threshold accuracy if selected model 308 is not applicable to other data sets, including testing set 306. Training using different features may include training using data from different sensors, different manufacturing parameters, etc. Responsive to determining that selected model 308 has an accuracy that meets a threshold accuracy based on testing set 306, flow continues to block 320. In at least block 312, the model may learn patterns in the training data to make predictions. In block 318, the system 300 may apply the model on the remaining data (e.g., testing set 306) to test the predictions.

At block 320, system 300 uses the trained model (e.g., selected model 308) to receive current data 322 and determines (e.g., extracts), from the output of the trained model, predictive data 324. Current data 322 may be manufacturing parameters related to a process, operation, or action of interest. Current data 322 may be manufacturing parameters related to a process under development, redevelopment, investigation, etc. Current data 322 may be or include a range of inputs to be used in determining, designing, or updating a PVD process. Current data 322 may include chamber configuration data, substrate geometry data, and process parameter data.

A corrective action associated with the manufacturing equipment 124 of FIG. 1 may be performed in view of predictive data 324. In some embodiments, current data 322 may correspond to the same types of features in the historical data used to train the machine learning model. In some embodiments, current data 322 corresponds to a subset of the types of features in historical data that are used to train selected model 308. For example, a machine learning model may be trained using a number of manufacturing parameters, and configured to generate output based on a subset of the manufacturing parameters.

In some embodiments, the performance of a machine learning model trained, validated, and tested by system 300 may deteriorate. For example, a manufacturing system associated with the trained machine learning model may undergo a gradual change or a sudden change. A change in the manufacturing system may result in decreased performance of the trained machine learning model. A new model may be generated to replace the machine learning model with decreased performance. The new model may be generated by altering the old model by retraining, by generating a new model, etc.

Generation of a new model may include providing additional training data 346. Generation of a new model may further include providing current data 322, e.g., data that has been used by the model to make predictions. In some embodiments, current data 322 when provided for generation of a new model may be labeled with an indication of an accuracy of predictions generated by the model based on current data 322. Additional training data 346 may be provided to model training of block 312 for generation of one or more new machine learning models, updating, retraining, and/or refining of selected model 308, etc.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIG. 3 depicts a system configured for training, validating, testing, and using one or more machine learning models. The machine learning models are configured to accept data as input (e.g., set points provided to manufacturing equipment, sensor data, metrology data, etc.) and provide data as output (e.g., predictive data, corrective action data, classification data, etc.). Partitioning, training, validating, selection, testing, and using blocks of system 300 may be executed similarly to train a second model, utilizing different types of data. Retraining may also be performed, utilizing current data 322 and/or additional training data 346.

FIGS. 4A-C are flow diagrams of methods 400A-C associated with utilizing models to predict and/or correct substrate particle defect root causes, according to certain embodiments. Methods 400A-C may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-C may be performed, in part, by predictive system 110. Method 400C may be performed, in part, by predictive system 110 (e.g., server machine 170 and data set generator 172 of FIG. 1, data set generator 272 of FIG. 2). Predictive system 110 may use method 400A to generate a data set to at least one of train, validate, or test a model (e.g., a physics-based model, a reduced order model, a machine learning model), in accordance with embodiments of the disclosure. Methods 400B-C may be performed by predictive server 112 (e.g., predictive component 114) and/or server machine 180 (e.g., training, validating, and testing operations may be performed by server machine 180). In some embodiments, a non-transitory machine-readable storage medium stores instructions that when executed by a processing device (e.g., of predictive system 110, of server machine 180, of predictive server 112, etc.) cause the processing device to perform one or more of methods 400A-C.

For simplicity of explanation, methods 400A-C are depicted and described as a series of operations. However, operations in accordance with this disclosure can occur in various orders and/or concurrently and with other operations not presented and described herein. Furthermore, not all illustrated operations may be performed to implement methods 400A-C in accordance with the disclosed subject matter. In addition, those skilled in the art will understand and appreciate that methods 400A-C could alternatively be represented as a series of interrelated states via a state diagram or events.

FIG. 4A is a flow diagram of a method 400A for generating a data set for a model, according to some embodiments. Referring to FIG. 4A, in some embodiments, at block 401 the processing logic implementing method 400A initializes a training set T to an empty set.

At block 402, processing logic generates first data input (e.g., first training input, first validating input) that may include one or more of manufacturing parameters, metrology data, process chamber condition data, etc. In some embodiments, the first data input may include a first set of features for types of data and a second data input may include a second set of features for types of data (e.g., as described with respect to FIG. 3). Input data may include historical data and/or data output by a model (e.g., a physics-based model output used for training a machine learning model).

In some embodiments, at block 403, processing logic optionally generates a first target output for one or more of the data inputs (e.g., first data input). In some embodiments, the input includes one or more manufacturing parameters and the target output is an indication related to predicted properties of a substrate processed in a PVD process. In some embodiments, the target output is a recommended corrective action, such as an update to a process recipe for a PVD process. In some embodiments, the first target output is predictive data.

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing a machine learning model, such as model 190 of FIG. 1. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, a model (e.g., model 190) can be at least one of trained using training engine 182 of server machine 180, validated using validating engine 184 of server machine 180, or tested using testing engine 186 of server machine 180. The trained model may be implemented by predictive component 114 (of predictive server 112) to generate predictive data 168 for performing signal processing, or for performing a corrective action associated with manufacturing equipment 124.

FIG. 4B is a flow diagram of a method 400B for utilizing a model for predicting and/or correcting a PVD process of a substrate processing system, according to some embodiments. At block 410, processing logic optionally obtains user selection related to PVD modeling. The user selection may be obtained via a GUI. The user selection may include simulation inputs. The user selection obtained via the GUI may include geometrical features of a substrate provided for PVD processing, e.g., substrate geometry parameters. In some embodiments, via the GUI, a user may be provided with a list of common substrate features or common substrate feature types (e.g., feature shapes, functional geometries, or the like). The user may select a feature from the list, and be provided with a set of associated parameters (e.g., dimensions of various portions of the substrate feature). The user may provide values for each of the provided parameters. In some embodiments, a user may select a generic or custom feature profile, and may provide a more detailed description of a substrate feature to be modeled (e.g., a file indicating height of an upper substrate surface across the span of the feature, or the like).

At block 412, process logic provides the simulation inputs (which may have been obtained from a user via the GUI) to a PVD model. The PVD model may be or include a trained machine learning model. The PVD model may be or include a physics-based model. The PVD model may include a model directed toward predicting properties of high-energy particles used for sputtering, e.g., a plasma model. The PVD model may include a model directed toward predicting interactions between particles, e.g., a kinetic Monte Carlo model, a level set model, or the like configured to predict interactions between high-energy particles and a sputtering target.

In some embodiments, the simulation inputs may include chamber configuration parameters, process recipe parameters, and/or substrate geometry parameters. The chamber configuration parameters may include selection of a process chamber (e.g., a type, design, or model of process chamber, or a specific process chamber, such as in the event that different process channels have associated PVD models, associated digital twins, or the like). The chamber configuration parameters may include selection of sputtering target material. The chamber configuration parameters may include selection of sputter gas. The chamber configuration parameters may include selection of a distance between a sputtering target and a deposition target. The substrate geometry parameters may include indications of dimensions (e.g., spatial dimensions) of a feature of the substrate.

In some embodiments, multiple sets of simulation inputs may be provided. For example, an array of process inputs may be represented, and output predicted property results analyzed to determine which of the inputs generates target results. In some embodiments, a file including simulation inputs, instructions defining an experiment including multiple simulation runs, or the like may be referenced by the modeling software to perform the PVD modeling. In some embodiments, the file may be provided to the PVD modeling by a user via the GUI.

At block 414, process logic obtains output from the PVD model including predicted properties of a substrate processed in accordance with the simulation inputs. In some embodiments, different types of PVD processes may be modeled. In some embodiments, a user may select a type of PVD process via the GUI, e.g., a gapfill or liner application.

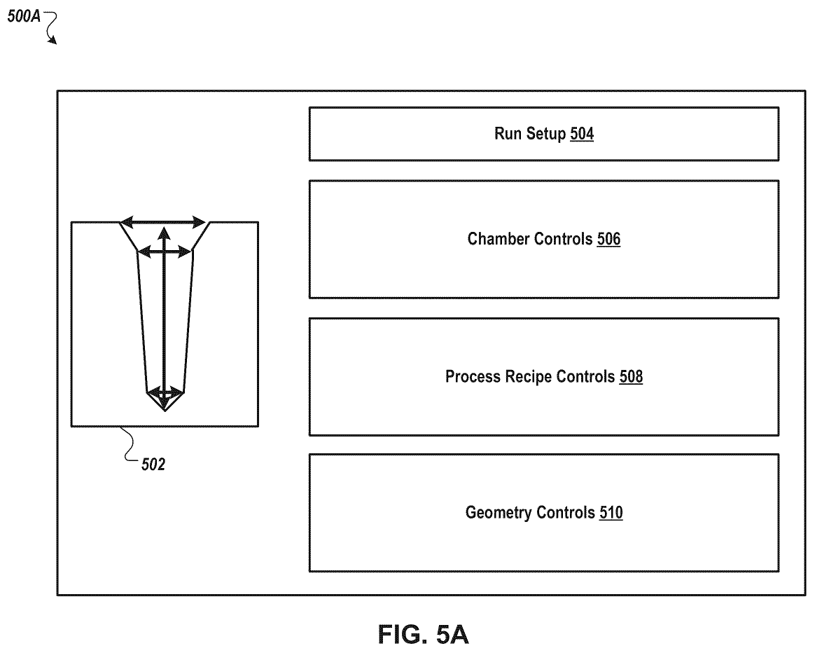

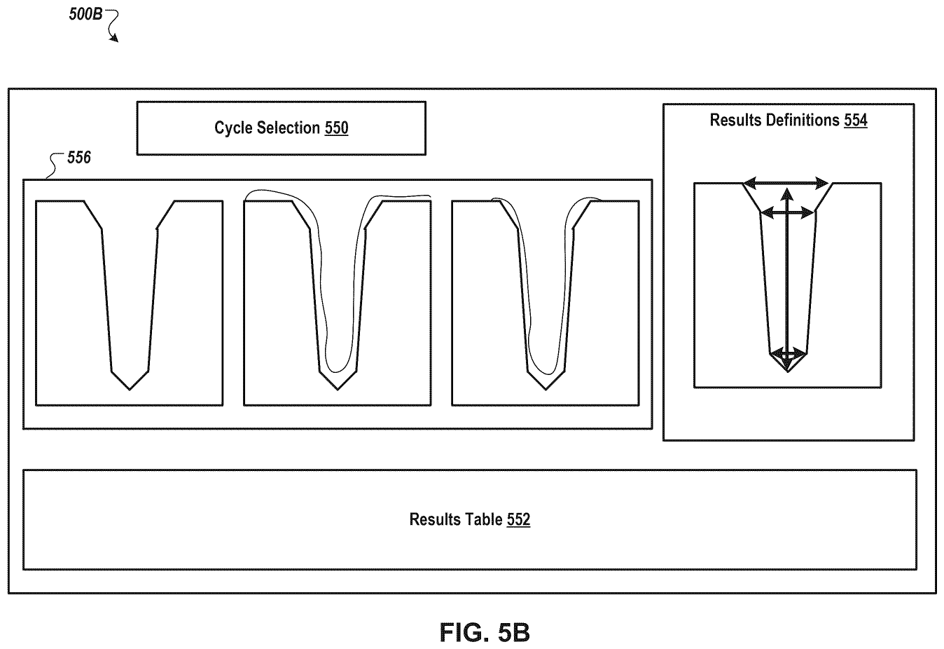

At block 416, process logic provides an alert to a user including the predicted properties. The alert may be provided via the GUI. The alert may include data, visualizations, indications of confidence intervals, or the like. Optionally, at block 418, process logic may provide a visualization of the substrate exhibiting the predicted properties via the GUI. Further discussion of an example GUI that may be used in connection with a PVD model may be found in connection with FIGS. 5A-B.

Optionally at block 420, process logic performs a corrective action in view of the predicted properties. The corrective action may include updating a process recipe. The corrective action may include scheduling reconfiguration of a process chamber (e.g., in relation to chamber configuration parameters). The corrective action may include scheduling maintenance of the process chamber. The corrective action may include updating target properties (e.g., geometry) of a substrate to be provided to a PVD process operation associated with the modeling system.

FIG. 4C is a flow diagram of a method 400C for training a machine learning model to generate predictive PVD data, according to some embodiments. At block 430, process logic optionally provides first simulation inputs to a physics-based PVD model. The simulation inputs may be related to process inputs, e.g., process knobs. Process logic may obtain from the physics-based PVD model output. The output may include predictions of substrate properties in association with the first simulation inputs. The predictions of substrate properties based on the physics-based PVD model may be used as target output for training a machine learning model.

At block 432, process logic obtains training input data. The training input data may be or include the simulation inputs of block 430, or may be related to the simulation inputs of block 430 (e.g., combinations, features, or attributes related to the simulation inputs, or the like). The training input data may include chamber configuration parameters, process recipe parameters, and/or substrate geometry parameters. The chamber configuration parameters may include chamber selection, sputtering target selection, sputter gas selection, sputter distance selection, etc. Substrate geometry parameters may include dimensions of at least one feature of a substrate provided for PVD processing.

At block 434, process logic obtains target output data including properties of a plurality of substrate processed in accordance with the training data in a PVD process. In some embodiments, the target output data may be or include metrology data. In some embodiments, the target output data may be or include output of a physics-based PVD model.

At block 436, process logic trains a machine learning model to generate a trained machine learning model. The training is performed based on the training input data and the target output data.

FIG. 5A depicts an example input GUI 500A for operation of a PVD model in association with substrate processing operations, according to some embodiments. GUI 500A includes substrate feature depiction 502. The substrate feature depiction may provide a visual indicator of a substrate feature (e.g., a substrate feature with properties provided as input substrate geometry to GUI 500A). Substrate feature depiction 502 may include one or more indicators of definitions of spatial parameters, e.g., as labeled arrows or brackets indicating corresponding dimensions of the substrate feature.

Run setup 504 may be or include one or more GUI elements for collecting user input regarding types of experiment, number of runs, variations in data, etc. Run setup 504 may include a GUI element for browsing or otherwise providing a file (e.g., a CSV file, spreadsheet file, or the like) indicating an array of experimental conditions that may be provided to the PVD model, e.g., for determining which conditions best reflect target substrate performance results.

Chamber controls 506 (and any other applicable UI elements of GUIs described herein) may include drop-down menus, fillable fields, definitions, selections, or other elements for providing information to a user and collecting information from a user. Chamber controls 506 may include elements for a user to provide chamber configuration parameters, e.g., as discussed in connection with block 412 of FIG. 4B. Chamber controls 506 may include user-provided particle angular distribution, e.g., an angle distribution function, a particle angular distribution function, etc. Chamber controls 506 may include user-provided particle energy distribution, e.g., energy distribution function, particle energy distribution function, etc. Chamber controls 506 may include sputtering yield (e.g., particle yield). In some embodiments, modeling of a plasma system may perform modeling of one or more of angular distribution, energy distribution, and/or sputtering yield. In some embodiments, chamber controls 506 may include options for a user to determine whether the modeling system is to use user-provided values or functions for one or more parameters, standard value or functions, modeled values or functions, or the like.

Process recipe controls 508 include elements for a user to provide process recipe information in association with PVD modeling. Process recipe controls 508 may include an element for providing a number of cycles (or an alternate endpointing condition, such as deposition layer thickness), type of process (e.g., liner, gapfill, deposition, cyclic deposition, deposition and etch, cyclic deposition and etch, or the like). Process recipe controls 508 may provide fields or elements for a user to input any metrics of interest with respect to the PVD process recipe, including plasma energy, time, gas mix, temperature, etc. The GUI may present different elements based on user selection of one or more options, settings, specifications, or the like.

Geometry controls 510 includes elements for a user to indicate properties of a substrate provided to the PVD process associated with GUI 500A. Geometry controls 510 may include an element (e.g., drop-down menu) for selecting from a number of common feature types (e.g., trench, via, etc.). Geometry controls 510 may include an element for selecting a dimensionality of features, e.g., one-, two-, or three-dimensional geometries of interest. Geometry controls 510 may include elements for defining various properties or values of portions of the feature of interest, e.g., as defined in substrate feature depiction 502. In some embodiments, the substrate feature depiction 502 may change based on user selection of a feature type, user input of one or more geometric parameters, or the like. In some embodiments, GUI 500A may include other elements not shown, such as options for outputting PVD model data (e.g., file location, email address, etc.), or other elements that may provide additional functionality.

FIG. 5B depicts example output GUI 500B for displaying results associated with performing PVD modeling, according to some embodiments. GUI 500B includes cycle selection 550. Modeling results associated with the selected cycle (e.g., results from the selected cycle of processing, results up to the selected cycle of processing, or the like) may be displayed via GUI 500B.

GUI 500B may include results images 556. Results images 556 may be or include a graphical representation of substrate properties. Results images 556 may include images of substrates associated with a currently selected cycle, e.g., via cycle selection 550. Results images 556 may include one or more images of a substrate structure after processing. In some embodiments, results images 556 may include images of a substrate structure before processing, e.g., for displaying adjustments made to substrate geometry by processing. For multi-step processes, e.g., deposition/etch cyclic processes, results images 556 may for example include images of predicted substrate properties after various operations, e.g., an image of the substrate before processing, an image after deposition operations, and an image after etch operations.

GUI 500B may include a GUI element of results definitions 554. Results definitions 554 may assist a user in interpreting results provided via GUI 500B. Results definitions 554 may include a picture with one or more labels, e.g., of dimensions of aspects of the feature.

Definitions displayed in results definitions 554 (e.g., pictures, labels, description, etc.) may be adjusted based on one or more user selections. For example, definitions relevant to gapfill or liner applications may be displayed, including dimensions relevant to these applications. For example, liner applications may include drawings, definitions, labels, etc., related to sidewall average film thickness, bottom film thickness, opening critical dimension, sidewall thickness at one or more depths of interest, or the like. For a gapfill application, results definitions 554 may include drawings, definitions, labels, etc., related to void area or volume, void critical dimension, void location (e.g., compared to feature bottom, compared to feature sidewalls, etc.), or the like.

GUI 500B may include results table 552. Results table 552 may be or include a numerical representation of substrate properties. Results table 552 may include tabulated data related to output of the PVD model. Results table 552 may include results of dimensions of the feature included in results definitions 554. Results table 552 may include results for an endpoint of the PVD process, results for every cycle of the PVD process, results for a subset of cycles of the PVD process, results for cycles up to the currently selected cycle of the PVD process, or the like. Results table 552 may include results related to the modeling process of interest, e.g., including values related to feature dimensions described in results definitions 554.

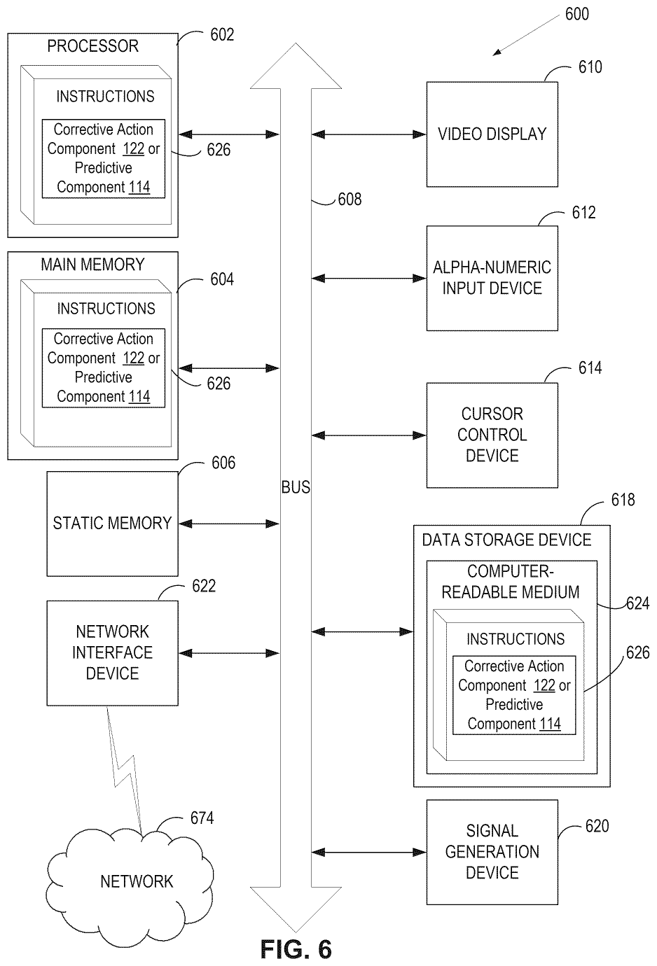

FIG. 6 is a block diagram illustrating a computer system 600, according to some embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium, non-transitory machine-readable storage medium, or the like) on which may store instructions 626 encoding any one or more of the methods or functions described herein, including instructions encoding components of FIG. 1 (e.g., predictive component 114, corrective action component 122, model 190, etc.) and for implementing methods described herein. For example, instructions 626 may encode components for generating, calibrating, or running PVD modeling operations, as described herein. The non-transitory machine-readable storage medium may store instructions which are used to execute methods related to modeling gas dynamics of a process chamber, adjusting processing system operations to improve substrate processing operations, reducing gas backflow to reduce particle deposition, or the like.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method comprising:
obtaining, via one or more graphical user interface (GUI) elements, simulation inputs comprising at least one of chamber configuration parameters, process recipe parameters, or substrate geometry parameters associated with a physical vapor deposition (PVD) process;
providing the simulation inputs to a PVD model;
obtaining output from the PVD model comprising predicted properties of a substrate processed in accordance with the simulation inputs;
providing information to a user comprising the predicted properties, the information comprising (a) a graphical representation or numerical representation of the predicted properties presented via a first GUI element and (b) a graphical representation of definitions of the predicted properties presented via a second GUI element.

2. The method of claim 1, further comprising:
obtaining, via the GUI, a user selection of the simulation inputs comprising chamber configuration parameters, process recipe parameters, and substrate geometry parameters; and
providing a visualization of the substrate exhibiting the predicted properties via the GUI based on the chamber configuration parameters, process recipe parameters, and substrate geometry parameters.

3. The method of claim 1, wherein the simulation inputs comprise a plurality of sets of simulation inputs, each set of the plurality of sets associated with a PVD process, and wherein the output from the PVD model comprises predicted properties of a plurality of substrates, each associated with one of the plurality of sets of simulation inputs.

4. The method of claim 1, wherein the chamber controls comprise one or more of:
selection of a model or design of process chamber;
selection of a sputtering target material;
selection of a sputter gas;
providing a particle angular distribution function;
providing a particle energy distribution function;
providing sputtering yield; or
selection of a distance between a sputtering target and deposition target.

5. The method of claim 1, wherein the substrate geometry parameters comprise an indication of dimensions of at least one feature of the substrate provided for processing in accordance with the simulation inputs.

6. The method of claim 5, wherein obtaining the substrate geometry parameters comprises:
providing, via a graphical user interface (GUI), a set of common substrate feature types;
obtaining a user selection of a first feature type of the set of common substrate feature types via the GUI; and
obtaining user input of one or more spatial parameters in association with the substrate and the first feature type.

7. The method of claim 1, wherein the PVD model comprises a first physics-based model configured to predict properties of a plasma generating high-energy particles for sputtering, and a second physics-based model configured to predict interactions between high-energy particles and a sputtering target.

8. The method of claim 1, wherein the PVD model comprises a trained machine learning model.

9. The method of claim 1, wherein the PVD model is configured to predict process results of types of process operations comprising one or more of:
liner applications, to provide a coating of material on one or more surfaces of a substrate feature; or
gapfill applications, to fill a feature of a substrate with material.

10. The method of claim 1, further comprising performing a corrective action in view of the predicted properties of the substrate, wherein the corrective action comprises one or more of:
updating a process recipe;
scheduling reconfiguration of a process chamber;
updating a target substrate geometry to be provided to a process operation; or
scheduling maintenance of the process chamber.

11. A method, comprising:
obtaining training input data comprising first simulation inputs, the first simulation inputs comprising chamber configuration parameters, process recipe parameters, and substrate geometry parameters;
obtaining target output data comprising properties of a plurality of substrates processed in accordance with the training input data in a physical vapor deposition (PVD) process; and
training a machine learning model to generate a trained machine learning model based on the training input data and the target output data.

12. The method of claim 11, further comprising:
providing the first simulation inputs to a physics-based PVD model; and
obtaining output from the physics-based PVD model based on the first simulation inputs, wherein the target output data comprises the output from the physics-based PVD model.

13. The method of claim 11, wherein the chamber configuration parameters comprise one or more of:
selection of a model or design of process chamber;
selection of a sputtering target material;
selection of a sputter gas;
providing an angular distribution function;
providing an energy distribution function;
providing particle yield; or
selection of a distance between a sputtering target and deposition target.

14. The method of claim 11, wherein the substrate geometry parameters comprise an indication of dimensions of at least one feature of the substrate provided for processing in accordance with the simulation inputs.

15. A non-transitory machine-readable storage medium, storing instructions which, when executed, cause a processing device to perform operations comprising:
obtaining, via one or more graphical user interface (GUI) elements, simulation inputs comprising at least one of chamber configuration parameters, process recipe parameters, or substrate geometry parameters associated with a physical vapor deposition (PVD) process;
providing the simulation inputs to a PVD model;
obtaining output from the PVD model comprising predicted properties of a substrate processed in accordance with the simulation inputs;
providing information to a user comprising the predicted properties, the information comprising (a) a graphical representation or numerical representation of the predicted properties presented via a first GUI element and (b) a graphical representation of definitions of the predicted properties presented via a second GUI element.

16. The non-transitory machine-readable storage medium of claim 15, wherein the operations further comprise:
obtaining, via the GUI, a user selection of the simulation inputs comprising chamber configuration parameters, process recipe parameters, and substrate geometry parameters; and
providing a visualization of the substrate exhibiting the predicted properties via the GUI based on the chamber configuration parameters, process recipe parameters, and substrate geometry parameters.

17. The non-transitory machine-readable storage medium of claim 15, wherein the chamber controls comprise one or more of:
selection of a model or design of process chamber;
selection of a sputtering target material;
selection of a sputter gas; or
selection of a distance between a sputtering target and deposition target.

18. The non-transitory machine-readable storage medium of claim 15, wherein the substrate geometry parameters comprise an indication of dimensions of at least one feature of the substrate provided for processing in accordance with the simulation inputs, and wherein obtaining the substrate geometry parameters comprises:
providing, via a graphical user interface (GUI), a set of common substrate feature types;
obtaining a user selection of a first feature type of the set of common substrate feature types via the GUI; and
obtaining user input of one or more spatial parameters in association with the substrate and the first feature type.

19. The non-transitory machine-readable storage medium of claim 15, wherein the PVD model is configured to predict process results of types of process operations comprising one or more of:
liner applications, to provide a coating of material on one or more surfaces of a substrate feature; or
gapfill applications, to fill a feature of a substrate with material.

20. The non-transitory machine-readable storage medium of claim 15, wherein the operations further comprise performing a corrective action in view of the predicted properties of the substrate, wherein the corrective action comprises one or more of:
updating a process recipe;
scheduling reconfiguration of a process chamber; or
scheduling maintenance of the process chamber.
